(19) United States
(12) Patent Application Publication
(10) Pub. No.: US 2016/0254834 A1
(43) Pub. Date: Sep. 1, 2016

(54) CARD STORAGE TYPE MOBILE DEVICE CASE WITH SLIDE COVER

(71) Applicant: DESIGN SKIN, Mapo-gu Seoul (KR)

(72) Inventor: Chanhong PARK, Seoul (KR)

(21) Appl. No.: 14/772,049

(22) PCT Filed: Aug. 5, 2014
(86) PCT No.: PCT/KR2014/007231

§ 371 Date: Sep. 1, 2015

(30) Foreign Application Priority Data
Nov. 22, 2013 (KR) 20-2013-0009630

(51) Int. Cl. H04B 1/3888

(52) U.S. Cl. CPC H04B 1/3888

(57) ABSTRACT

A mobile device case comprises a case body having, at one slide thereof, a device receiving part for accommodating a mobile device; a slide cover which is slidably coupled to the opposite side of the device receiving part; and a card receiving part which is recessedly formed on at least one of the two opposite surfaces of the case body and the slide cover. A mobile device case comprises: a first body section having, at one side thereof, a device receiving part for accommodating a mobile device; a second body section which is fixedly secured to the opposite side of the device receiving part of the body of the receiving part and which has a card receiving part that is recessedly formed; and a slide cover which is slidably coupled to the first body section.

### TECHNICAL FIELD

The invention relates to a mobile case, and more specifically to a mobile case that protects a mobile device such as a smartphone from external shock, and provides user convenience.

### TECHNOLOGICAL BACKGROUND

Since the universalization of portable phones, various other types of portable devices such as portable multimedia players (PMP, portable multimedia player), personal digital assistants (PDA), portable DMB TVs, portable game devices, and electronic dictionaries have been used. With the recent emergence of smartphones, there has been a trend in which various existing portable devices are being integrated into a smartphone.

While portability has improved with the integration of various functions into one device such as a smartphone, the price of devices has increased. Therefore, there is an increased need to protect mobile devices from unexpected situations such as shock from dropping them, and the usage of smartphone cases, such as bumpers, has become widespread.

Meanwhile, many individuals have started carrying mobile devices such as smartphones at all times as dependency on smartphones has increased in daily life. In a situation where the use of credit cards or debit cards is universal, there are increased demands from people who want to go out carrying just one or two cards and a smartphone instead of a wallet.

Although smartphone cases, such as flip-type covers made of leather, etc., have been released to meet such demands, these demands that pursue a more simple and elegant appearance with the safety and durability of card storage have not been satisfied. Also, a portable device case with a slide cover has been released as shown in the preceding patent literature, but a configuration that can simultaneously provide the convenience and durability that users need, with an elegant appearance has not been presented to this date.

### DETAILED DESCRIPTION OF INVENTION

### Problems to Solve

In response to the said demand, the purpose of the invention is to provide a card storage mobile device case with a slide cover that can protect mobile devices such as smartphones, can store cards such as credit cards securely, and has a configuration that can simultaneously provide convenience and an elegant appearance.

### Solutions to Problems

In order to solve the said problem, the mobile device case, according to one aspect of the invention, comprises a case body that has a device receiving part that receives the mobile device on one side; a slide cover that joins to allow opening and closing on the opposite side of the said case body's said device receiver; and a recessedly formed card storage on at least one side of the two surfaces of the said case body and said slide cover that face each other.

The said card storage may be formed in a recessed groove on the said case body.

A slide rail with an undercut (under cut) form on the two outer walls of the said card storage may be equipped.

A bevel that connects to the said recessed groove on the said card storage's lower side wall may be created.

The mobile device case, according to another aspect of the invention, comprises a first body that has a device receiver that receives the mobile device; a second body that joins the opposite side of the said receiver body's device receiver and has a recessedly formed card storage; a slide cover that joins to allow the opening and closing of the said card storage on the said first body via a slide method.

The said second body may be created in a synthetic resin of relatively higher hardness than the said first body.

A slide rail built in an undercut (under cut) form on two outer walls of the said card storage may be equipped in the said second body.

The said second body and the said card storage may be made with the same synthetic resin.

Meanwhile, the said first body can be made of polyurethane or silicon rubber, and the said second body may be made with polycarbonate or ABS resin.

A bevel that connects to the said recessed groove on the said card storage's lower side wall may be formed on the said second body.

The recessedly formed card receiving part may be formed by boring a part of the second body, so that a surface of the first body is exposed so as to form a bottom thereof.

### Effects of Inventions

According to the invention, it has effects that protect mobile devices such as smartphones, securely store cards such as credit cards, and provide a card storage type mobile device case that has a slide cover with a configuration that can provide convenience and an elegant appearance.

### BRIEF DESCRIPTION OF DRAWINGS

FIG. 1 is a perspective view that shows the mobile case's slide cover in an opened state, according to an embodiment of the invention.

FIG. 2 is a disassembled perspective view that shows the slide cover from the said embodiment in FIG. 1 in a disassembled state.

FIG. 3 is a cross-sectional view along a line III-III′ of FIG. 2.

FIG. 4 is a perspective view of a mobile device case viewed from the device receiver, according to the said embodiment in FIG. 1.

FIG. 5 is a side view of the said embodiment in FIG. 1, viewed from the right side of the slide cover.

### DETAILED DESCRIPTION OF EMBODIMENTS OF INVENTION

The embodiment of the invention will be described below using the attached diagrams. The embodiment that will be described below can be modified into various forms, and this invention's scope is not limited to the embodiments below or the mentioned modification example. This invention's embodiment is provided in order to clearly convey the invention's technical ideologies to persons with general knowledge in the relevant field.

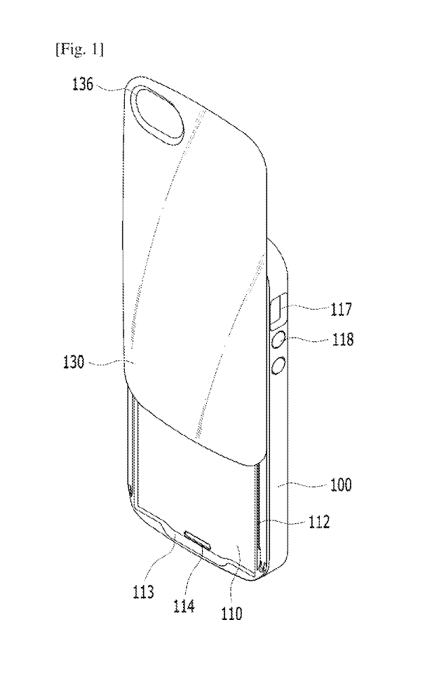

FIG. 1 is a perspective view that shows the mobile case's slide cover in an opened state according to an embodiment of the invention. A mobile device case according to the invention has a case body (100) that receives the mobile device, a slide cover (130) that joins the said case body (100) to allow opening and closing via a slide method, and a card storage (110) that is created to be able to store at least one card in between the said case body (100) and the said slide cover (130).

In this embodiment, the said card storage (110) may be created on one side of the said case body (100), more specifically in a recessed groove that fits the form of a card that is to be stored on the opposite side of the device receiver that receives a mobile device. In contrast, in a case where the said slide cover (130) has sufficient thickness, it can also be formed inside of the said slide cover (130) in the form of a recessed groove.

As it pertains to this embodiment, walls that protrude towards the said slide cover (130) further than the bottom surface of the said card storage (110) are formed on both sides and the lower part of the said card storage (110) from the mobile device case. Although not shown in detail in this figure, a slide rail that guides the movement of sliding motion of the said slide cover (130) can be built on both side walls (112). On the bottom side walls in the lower part of the said card storage (110), a bevel (113) may be formed to allow a user's finger (mainly the fingernail part) to easily reach the side of a card when taking out a stored card. More bottom grooves (114) may be formed on the bottom surface of the said card storage (110) that is close to the said bevel (113). The said bottom grooves (114) provides a space that allows the entry of the user's fingernail etc., under the lower part of a stored card, which helps the user take out a card with ease by lifting the card.

Meanwhile, a hole or a button is provided in places of the said slide cover (130) and the said case body (100) to avoid interference while using the received mobile device.

For example, on the upper part of the said slide cover (130) is a camera hole (136) that exposes the mobile device's camera and flash to the outside, and on the side of the said case body (100) are buttons (118) that move flexibly in correspondence with the mobile device's buttons and an interface hole (117) for power or connecting external devices. For such holes, the location or form of buttons will differ according to the type of mobile device to be received.

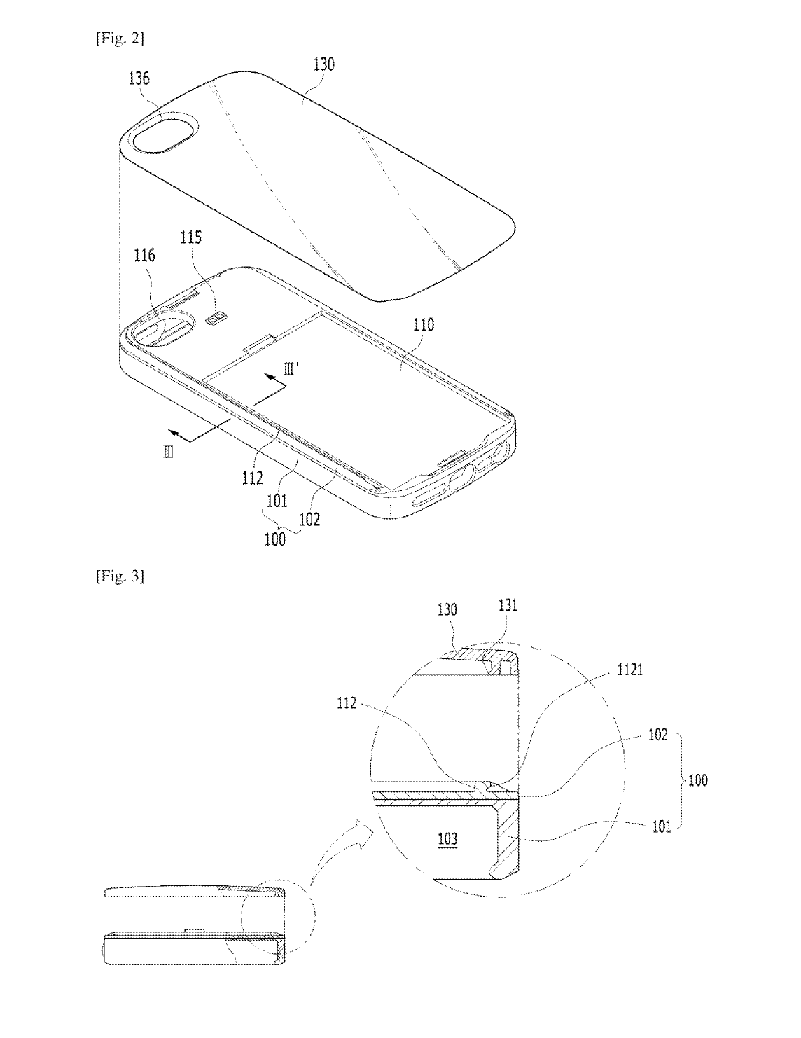

FIG. 2 is a disassembled perspective view of the slide cover in the embodiment of FIG. 1 in a disassembled state. In this figure, the inner structure of the said slide case (130) of the said case body (100) can be seen. A camera hole (116) is provided to accommodate the said camera hole (136) in the said case body (100). The said case body (100) may comprise two parts made of different materials. In other words, it may comprise the first body (101) that has a device receiver that receives the mobile device in the rear of this figure and the second body (102) with a side that faces the said slide cover (130). These can each be molded and attached or be formed as one unit through methods such as insert injection.

The above described recessed groove card storage (110) and both side walls (112), etc. may be arranged in the second body (102). Unlike the embodiment, in order to deepen the depth of the said card storage (110), the part that corresponds to the said card storage (110) in the said second body (102) was pierced so that one side of the exposed first body (101) would form the floor of the said card storage (110).

In terms of material, the said first body (101) may be created using materials such as synthetic resins that provide a buffer effect that can protect the received mobile device from external shock from falling, for example, polyurethane or silicone rubber. The said second body (102) can be made with materials that are relatively higher in hardness than the said first body (101) and can be made with the same material as the said slide cover (130). Examples of appropriate materials may be synthetic resins such as polycarbonate resin and ABS (acrylonitrile-butadiene-styrene) resins. When using the mobile device case according to the invention, high friction and weight is applied on the said second body (102) and the said slide cover (130) as a result of the opening and closing motion of the said slide cover (130). Therefore, material with sufficient level of hardness that can withstand this pressure is required. However, other materials can be used to fulfill these necessities.

Meanwhile, there may be a bump (115) that protrudes on the said slide cover (130) side outside of the card storage (110) unit on the side that faces the said slide cover (130) of the said second body (102). Though not pictured, the said guide bump (115) can guide the movement of the said slide cover (130) alongside the guide groove (not pictured), which is arranged to correspond with the said guide bump (115) at least for the length of the sliding section within the said slide cover (130). This type of structure can prevent damage to both side walls (112) of the said card storage (110) by diffusing the lateral load of the vertical substance that is applied in the sliding direction in the said slide cover (130).

FIG. 3 is a cross-sectional view along a line III-III′ of FIG. 2. The figure shows that the said case body (100) comprises a first body (101) with the device receiver (103) and the second body (102). The said second body (102) comprises a card storage and has walls on both sides (112) that are formed into slide rails (1121) in an under cut form on the outside. In the slide cover (130) is a slide bump (131) that interlocks with the said slide rails (1121) and moves in a sliding direction.

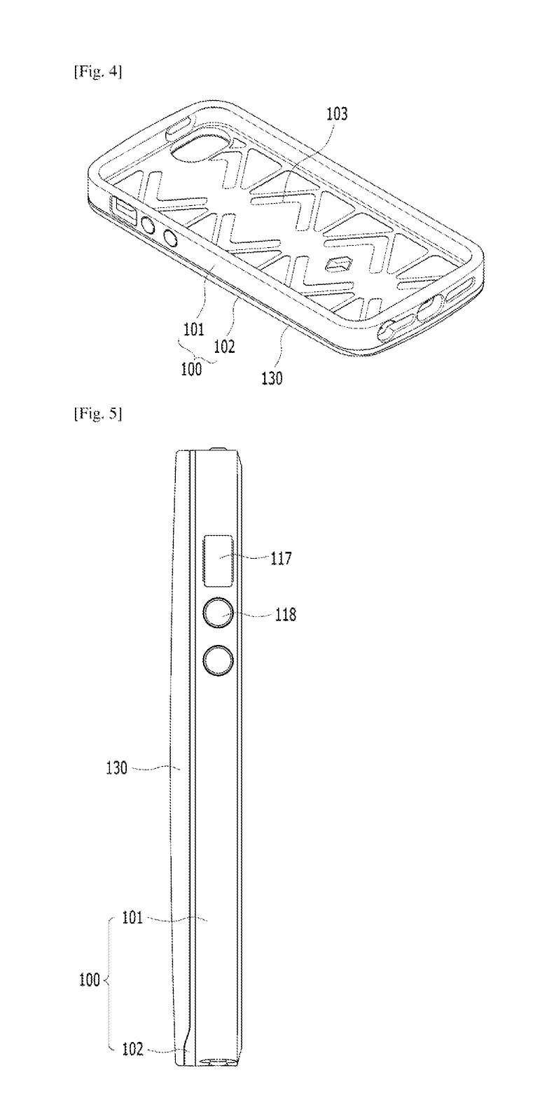

FIG. 4 is a perspective view of the mobile case in the embodiment of the said FIG. 1 from the perspective of the device receiver. When a mobile device such as a smartphone is placed inside the said device receiver (103) of the first body (101), the elasticity of the said first body's (101) material can support the mobile device so that it does not break away.

FIG. 5 is a side view of the slide cover in the embodiment of the said FIG. 1 from the right side. When the slide cover (130) is closed, it can be seen that the said side cover (130), the side of the second body (102), and the side of the first body (101) creates 3 layers. However, unlike this embodiment, it the side of the said slide cover (130) may cover the side of the said second body (102), and when the said first body (101) and the said second body (102) are made of one body of the same material, there may be two layers comprising a slide cover (130) and the case body (100) made of one body.

What is claimed is:

1. A mobile device case comprising:
a first body section having, at one side thereof, a device receiving part for accommodating a mobile device;
a second body section which is fixedly secured to an opposite side of the device receiving part of the body of the receiving part and which has a card receiving part that is recessedly formed; and
a slide cover which is slidably coupled to the first body section so as to be able to open and close the card receiving part,
wherein the second body section is made of synthetic resin having a hardness higher than the first body section.

2. The mobile device case of claim 1, wherein a pair of slide rails formed in under cut forms are provided along outer sides of both side walls of the card receiving part in the second body section.

3. The mobile device case of claim 1, wherein the second body section and the slide cover are made of a same synthetic resin.

4. The mobile device case of claim 1, wherein the first body section is made of polyurethane or silicon rubber, and wherein the second body section is made of polycarbonate or ABS resin.

5. The mobile device case of claim 1, wherein the recessedly formed card receiving part is made by cutting out of a portion of the second body section, so as to expose a portion of the first body section for a bottom floor of the card receiving part.

6. A mobile device case comprising:
a first body section having, at one side thereof, a device receiving part for accommodating a mobile device;
a second body section which is fixedly secured to an opposite side of the device receiving part of the body of the receiving part;
a card receiving part disposed between the first body and the second body; and
a slide cover connected slidably to the first body section so as to open and close the card receiving part over the second body,
wherein the second body section is made of synthetic resin having a hardness higher than the first body section.

7. The mobile device case of claim 6, wherein a pair of slide rails formed in under cut forms are provided along outer sides of both side walls of the card receiving part in the second body section.

8. The mobile device case of claim 6, wherein the second body section and the slide cover are made of a same synthetic resin.

9. The mobile device case of claim 6, wherein the first body section is made of polyurethane or silicon rubber, and wherein the second body section is made of polycarbonate or ABS resin.

10. The mobile device case of claim 6, wherein the card receiving part is formed recessedly on a portion of the second body section.

11. The mobile device case of claim 6, wherein the card receiving part is made by cutting out of a portion of the second body section, so as to expose a portion of the first body section for a bottom floor of the card receiving part.

12. The mobile device case of claim 11, wherein the card receiving part further comprises a recessed groove provided on a surface of the first body forming a bottom floor of the card receiving part.

13. The mobile device case of claim 6, wherein slide cover is configured to be slidable in a direction.

14. The mobile device case of claim 6, wherein slide cover is configured to be slidable in a length direction of the mobile device case.

15. The mobile device case of claim 6, wherein slide cover is configured to be slidable in a width direction of the mobile device case.
